(19) United States
(12) Patent Application Publication
(10) Pub. No.: US 2014/0304137 A1
(43) Pub. Date: Oct. 9, 2014

(54) Enclosed Software Platform and Method for the Financing of Creative Content/Productive Output

(71) Applicant: SQD Holdings LLC, McLean, VA (US)

(72) Inventors: Colin Charles Olson, Alexandria, VA (US); William Brett Sechrest, Arlington, VA (US); Erich Kipling Oliphant, Washington, DC (US)

(73) Assignee: SQD Holdings LLC, McLean, VA (US)

(21) Appl. No.: 14/231,091

(22) Filed: Mar. 31, 2014

Related U.S. Application Data
(60) Provisional application No. 61/808,682, filed on Apr. 5, 2013.

(51) Int. Cl. G06Q 40/04

(52) U.S. Cl. CPC G06Q 40/04
USPC 705/37

(57) ABSTRACT

A System and method that electronically allow consumers to invest in and obtain a product by presenting a website to a user, the website providing at least one product offering to a user. The system also electronically obtains one or more products to be displayed on a website that is associated with the system; the products may be obtained from one or more product creators or owners. The system also electronically allows users to view the products, invest in one or more product offerings, and purchase products.

### CROSS-REFERENCE TO RELATED APPLICATIONS

This application claims the benefit U.S. Provisional Application No. 61/808,682, filed Apr. 5, 2013 and herein incorporated by reference.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Field of the Invention

The present invention is in the technical field of software and the method of engaging with that software. In one aspect, the present invention is in the technical field of financial software. Beyond that, the present invention is in the technical field of financial software that facilitates the funding of creative content and/or productive output (e.g., physical products, potential physical products, services, financial services, digital arts, digital content and/or digital goods) by a plurality of individuals, the sale of said creative, digital, or other content or other goods and services to a plurality of individuals, and the tracking of monies owed to a plurality of individuals who have funded the creative content/productive output.

Producers of creative content/productive output (e.g., physical products, services, financial services, digital arts, and/or digital goods) struggle to bring their creative content/productive output to market. The cost associated with producing or owning creative content/productive output is usually onerous due to concentrated financing, marketing, and distribution services that can drive owners and/or creators into financial debt from which it is difficult to recover.

Bringing new physical products to market may be relatively difficult due to the capital-intensive nature of building, testing, and transporting physical products. Finding financing for the early stages of such ventures is often difficult enough to discourage all but the most ardent proponents of a new product. The pitfalls of product development and distribution are many for individuals and small businesses; a problem which generally leads to a lack of diversity and concentrates resources with those who are already blessed with such. Surprisingly, this concentration is also present within the digital sphere; an arena where one might expect more diversity due to the possibility of lower production and distribution costs. Consider in particular the music industry.

Traditional models of bringing new music or other digital content into the marketplace do not allow for much diversity for multiple reasons: (i) the short-term focus on quarterly profits by the large creative content companies does not allow content creators and owners to develop their skills and audience over time in a manner that supports the growth and depth of their art, (ii) the typical production company model places an onerous burden on the artist to perform within the confines of a short-term, profit-driven context that immerses the vast majority of artists in a debt burden that suffocates their ability to produce their art, (iii) the production company models drive all the initial revenues generated from the sales that come out of that creative content into their respective companies until all the production company's expenditures for that artist are returned in full; then a small portion of the revenues are funneled to the artists, (iv) if the artist's creative content does not return the out laid expenditures received from the production company, then the artist owes the balance of monies that have not been recouped. In many cases this is not the fault of the artist(s) but is in fact the fault of the company representing the artist, yet the artist retains the entire burden of repayment. Ultimately, the costs of production, marketing, and distribution can limit an artist's ability to reach a wider audience.

Peer-to-peer networks may alleviate the struggle of bringing independent artists' content to market. But here, the market is crowded and the ability to draw eyeballs, or ears, to independently-generated content is overpowered by the financial muscle of the dominant traditional content companies. The present invention helps alleviate this problem by enabling artists and owners to leverage the crowd to better compete with the onslaught of advertising dollars.

The problem of financing new artists can also be addressed by appealing to the crowd. Producers of creative content are beginning to gain support from gift crowd funding websites where individuals can financially support the artists' projects in return for a gift. This concept has been successful in bringing to market a wider range of choices for creative content but still does not go far enough. The problem is that the altruism of strangers (the gifts are by necessity small) can only provide so much funding for a project. The solution is to allow the crowd to benefit financially from the sale of creative content; to align the financial incentives of the crowd with that of the content creator. The present invention enables this alignment.

### BRIEF SUMMARY OF THE INVENTION

The present invention is a software platform and method that allows an individual to become a user of a platform provided by the invention and to sell goods, services, including all forms of digital content (their creative content and/or productive output) to other users through the platform. In addition, any user can offer to other users the right to buy a percentage of the monies generated by the sale of their creative content/productive output through the platform. The user whose creative content/productive output is to be sold has control of pricing as well as what proportion of their revenues (if any) they want to sell to other users. An enhanced incarnation of the platform would allow users who have purchased profit-sharing rights to sell their rights to third parties in a secondary market. The platform may be required to match buyers and sellers in the secondary market through an auction or similar price-discovery mechanism.

Use for the various embodiments of the invention are numerous since the embodiments: (1) allow users to raise immediate funds against the future value of their creative content/productive output; (2) allow users with creative content/productive output to build a cadre of individuals whose financial incentives are aligned with their own and are thus more likely to help advertise and protect said creative content/productive output; and (3) allow individuals with only modest amounts of capital to deploy their excess funds productively.

One embodiment of the invention allows users such as musicians to upload music to the site for sale to other users such as listeners who can sample, purchase, and download music through the platform. A third class of user such as investors can choose to purchase rights to a percentage of music sales if offered by the musician. All three classes of user are available to any individual who engages with the platform. Other incarnations include but are not limited to: digital 3D printing specifications, digital books, digital video, photography, graphic art, software, smart-phone applications, films, and so forth.

In another embodiment, the platform could be licensed to a company that wished to allow the public to invest directly in specific extant or future product lines. This is an unprecedented degree of fine-grained investment control, which is enabled by the algorithms and software comprising the platform. Companies could fund future products while simultaneously gauging the public's interest in one or more product lines. The public gains additional control over how their investment money is mobilized. Investors can enjoy the profits generated by products they believe are viable without suffering from the poor performance of other product lines generated by the company. Thus the platform provides for investors who are looking for opportunities beyond traditional investment options; investors who are interested in local or specific projects, the arts, the sciences, real estate, mortgages, movies, and government services. Investors will have choices that are transparent and focused such that they may build a diversified portfolio.

An aspect of the platform is that it is an enclosed system. That is to say, all creative content/productive output/goods/services are sold through the platform and all purchases of profit-sharing rights are conducted through the platform. Thus, there is no question about how much money has been made and how much is due to investors. Regulatory compliance can be easily handled as all data flowing through the system is tracked and recorded. The requirement that all creative content/productive output/goods/services output be sold through the platform ensures the enclosed nature of the system and illustrates that the invention is, in fact, a standalone market system that can be licensed to any entity for the sale of any creative content/productive output/goods/services. In addition, revenues generated through an online marketplace component created and managed by the platform can be shared by individuals and businesses who have purchased a right to a percentage of those revenues from the individuals or companies who have generated the creative content/productive output.

Some of the capabilities of the software and algorithms comprising the platform are as follows: (i) Management of user creative content/productive output through the site, including: user-directed pricing, user-specified uploads, user-specified bundling of creative content/productive output (e.g., music sold only as an album rather than individual tracks), and user-controlled presentation of creative content/productive output in their public facing pages, (ii) Allowing users to specify what percentage of sales of their creative content/productive output should be sold to the public, allowing users to specify how much money they would like to raise for said percentage, tracking the sale of such profit-sharing rights, and the management of the transfer of funds between investors and sellers when such rights are purchased, (iii) Tracking the sale of creative content/productive output and partitioning monies through transparent percentages of ownership between generators of and investors in said creative content/productive output, (iv) Allowing the users to browse, preview, and purchase creative content/productive output, (v) Allowing investors to browse and purchase offerings to share in the percentage of sales of creative content/productive output, (vi) Matching buyers and sellers of profit-sharing rights through price-discovery mechanisms, such as auctions, in incarnations that include a secondary market, (vii) Allowing all users to track monies they have made through the platform.

In another embodiment, the present invention concerns a system and method that electronically allows consumers to invest in and obtain a product by presenting a website to a user, the website providing at least one product offering to a user. The system also electronically obtains one or more products to be displayed on a website that is associated with the system; the products may be obtained from one or more content creators or owners. The system also electronically allows users to view the products, invest in one or more product offerings, and purchase products. As used herein, content creator or product creator also includes the owner of the product or content.

The products may be digital products and a product creator or owner may be allowed to assign a purchase price to the product. The product can also be a collection of one or more musical compositions such as individual songs comprising an album and the product creator is allowed to determine if individual songs may be sold.

As to the investment, the product creator or owner or website operator may specify an offering, including price, number of shares and other financial terms, for the sharing of revenues associated with the product, the offering representing a percentage of revenues retained by the creator and percentage of revenues sold to investors as a fixed number of shares at a fixed price per share representing a proportional split of investor revenue.

The system may also track, monitor and administer the purchases, investments and associated revenues as well the delivery of a product by electronic or other means thereby forming an enclosed system. The system may also only track, monitor and administer the purchases, investments and associated revenues thereby forming a semi-enclosed system.

### BRIEF DESCRIPTION OF THE SEVERAL VIEWS OF THE DRAWINGS

FIG. 1 conceptualizes the interaction between various categories of users and the content market and offering market that comprise the platform in one embodiment of the invention. The relationship between content and content offering is shown as are the components comprising a content line and an offering.

FIG. 2 illustrates the starting page of an embodiment of the platform that engages users as musicians, investors, and listeners and provides access to the content and offering markets.

FIG. 3 shows a beginning musician sign-up page accessed from the starting web page shown in FIG. 1.

FIG. 4 shows a page with a data acquisition process for creating a content offering by an artist such as a musician.

FIG. 5 shows a musician's private profile page while an offering is still under development.

FIG. 6 shows the typical state of a musician's private profile page where no offering is currently under development.

FIG. 7 shows a page (launched from the page shown in FIG. 6) where a musician can track income and sales statistics related to offerings they have sold to Investors within the platform.

FIG. 8 shows the offering market where users of the platform may browse summaries of pertinent information regarding offerings created by musicians and link to musicians' public pages (FIG. 9).

FIG. 9 shows a musician's public profile page where music and offerings may be purchased by other users.

FIG. 10 shows a pop-up dialogue box (accessed from page shown in FIG. 9) where a user may offer a price beyond the musician's minimum asking price for tracks or albums.

FIG. 11 shows a beginning investor sign-up page accessed from the starting web page shown in FIG. 1

FIG. 12 shows an investor's private account where they may manage their personal details, statements about yearly income, and can access pages for tracking and managing the offerings in which they have invested.

FIG. 13 shows a page (launched from the page shown in FIG. 12) where an investor can track income and sales statistics related to offerings they have purchased from musicians within the platform.

FIG. 14 shows the content market where users of the platform may browse summaries of pertinent information regarding albums offered for sale by musicians and navigate to musicians' public pages (FIG. 9).

### DETAILED DESCRIPTION OF THE INVENTION

This description is not to be taken in a limiting sense, but is made merely for the purpose of illustrating the general principles of the invention. The scope of the invention is defined by the appended claims. In a preferred embodiment, the present invention concerns an apparatus and a method for an online marketplace whereby the revenues generated by the sale of a creative content and/or productive output and/or a product which encompasses, but is not limited to, extant physical or digital goods or arts, yet-to-be-produced physical or digital goods or arts, services or anything else of value that may be sold including the tangible and intangible through the online marketplace can be shared by individuals and businesses who have purchased a right to a percentage of those revenues from the creators or owners.

The detailed description, which follows, is presented in part in terms of algorithms and symbolic representations of operations on data bits within a computer memory representing alphanumeric characters or other information. These descriptions and representations are the means used by those skilled in the art of data processing to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory; rather they represent specific electronic structural elements, which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present disclosure; the operations are machine operations. Useful machines for performing the operations of the present disclosure include general purpose digital computers or other similar devices. In all cases the distinction between the method operations in operating a computer and the method of computation itself should be recognized. The present disclosure relates to a method and apparatus for operating a computer in processing electrical or other (e.g., mechanical, chemical) physical signals to generate other desired physical signals.

The present disclosure also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below.

The present disclosure deals with object-oriented software, and particularly with an object-oriented operating system. The object-oriented software is organized into objects, each comprising a block of computer instructions describing various procedures (methods) to be performed in response to messages sent to the object or events which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions; for example, by a user activating an icon with a mouse pointer to generate an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a circle on a display may inherit functions and knowledge from another object for drawing a shape on a display.

A programmer programs in an object-oriented programming language by writing individual blocks of code, each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as is the case for sequentially organized programs. Nor is it easy to determine how an object-oriented program works through observation of the readily apparent manifestations of its operation. Most of the operations carried out by a computer in response to a program are invisible to an observer since relatively few steps in a program typically produce an observable computer output.

In the following description, several terms which may be used have the following meanings in the present context. The term object relates to a set of computer instructions and associated data, which can be activated directly or indirectly by the user. The terms windowing environment, running in windows, and object oriented operating system are used to denote a computer user interface in which information is manipulated and displayed on a video display such as within bounded regions on a raster scanned video display. The terms network, local area network, LAN, wide area network, or WAN mean two or more computers, which are connected in such a manner, that messages may be transmitted between the computers. In such computer networks, typically one or more computers operate as a server, a computer with large storage devices such as hard disk drives and communication hardware to operate peripheral devices such as printers or modems. Other computers, termed workstations, provide a user interface so that users of computer networks can access the network resources, such as shared data files, common peripheral devices, and inter-workstation communication. Users activate computer programs or network resources to create processes, which include both the general operation of the computer program along with specific operating characteristics determined by input variables and its environment.

The terms desktop, personal desktop facility, and PDF mean a specific user interface which presents a menu or display of objects with associated settings for the user associated with the desktop, personal desktop facility, or PDF. When the PDF accesses a network resource, which typically requires an application program to execute on the remote server, the PDF calls an Application Program Interface, or API, to allow the user to provide commands to the network resource and observe any output. The term Browser refers to a program which is not necessarily apparent to the user, but which is responsible for transmitting messages between the PDF and the network server and for displaying and interacting with the network user. Browsers are designed to utilize a communications protocol for transmission of text and graphic information over a worldwide network of computers, namely the World Wide Web or simply the Web. Examples of Browsers compatible with the present disclosure include the Internet Explorer program sold by Microsoft Corporation (Internet Explorer is a trademark of Microsoft Corporation), the Opera Browser program created by Opera Software ASA, the Safari browser program distributed by Apple, Inc., or the Firefox browser program distributed by the Mozilla Foundation (Firefox is a registered trademark of the Mozilla Foundation). Although the following description details such operations in terms of a graphic user interface of a Browser, the present disclosure may be practiced with text based interfaces, or even with voice or visually activated interfaces, that have many of the functions of a graphic based Browser.

Browsers display information which is formatted in a Standard Generalized Markup Language (SGML) or a HyperText Markup Language (HTML), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (XML) file, with XML files being capable of use with several Document Type Definitions (DTD) and thus more general in nature than SGML or HTML. The XML file may be analogized to an object, as the data and the style sheet formatting are separately contained (formatting may be thought of as methods of displaying information, thus an XML file has data and an associated method). Applets, small source code programs in a browser understandable programming language (for example, the Java programming language), may also be included in the web pages supplied to browsers. Web pages typically include one or more of these various files that the browser interprets and presents to the user.

The terms personal digital assistant or PDA, as defined above, means any handheld, mobile device that combines computing, telephone, fax, e-mail and networking features. The terms wireless wide area network or WWAN mean a wireless network that serves as the medium for the transmission of data between a handheld device and a computer. The term synchronization means the exchanging of information between a handheld device and a desktop computer either via wires or wirelessly. Synchronization ensures that the data on both the handheld device and the desktop computer are identical.

In wireless wide area networks, communication primarily occurs through the transmission of radio signals over analog, digital cellular, or personal communications service (PCS) networks. Signals may also be transmitted through microwaves and other electromagnetic waves. At the present time, most wireless data communication takes place across cellular systems using second generation technology such as code-division multiple access (CDMA), time division multiple access (TDMA), the Global System for Mobile Communications (GSM), personal digital cellular (PDC), or through packet-data technology over analog systems such as cellular digital packet data (CDPD) used on the Advance Mobile Phone Service (AMPS).

The term wireless application protocol or WAP means a universal specification to facilitate the delivery and presentation of web-based data on handheld and mobile devices with small user interfaces.

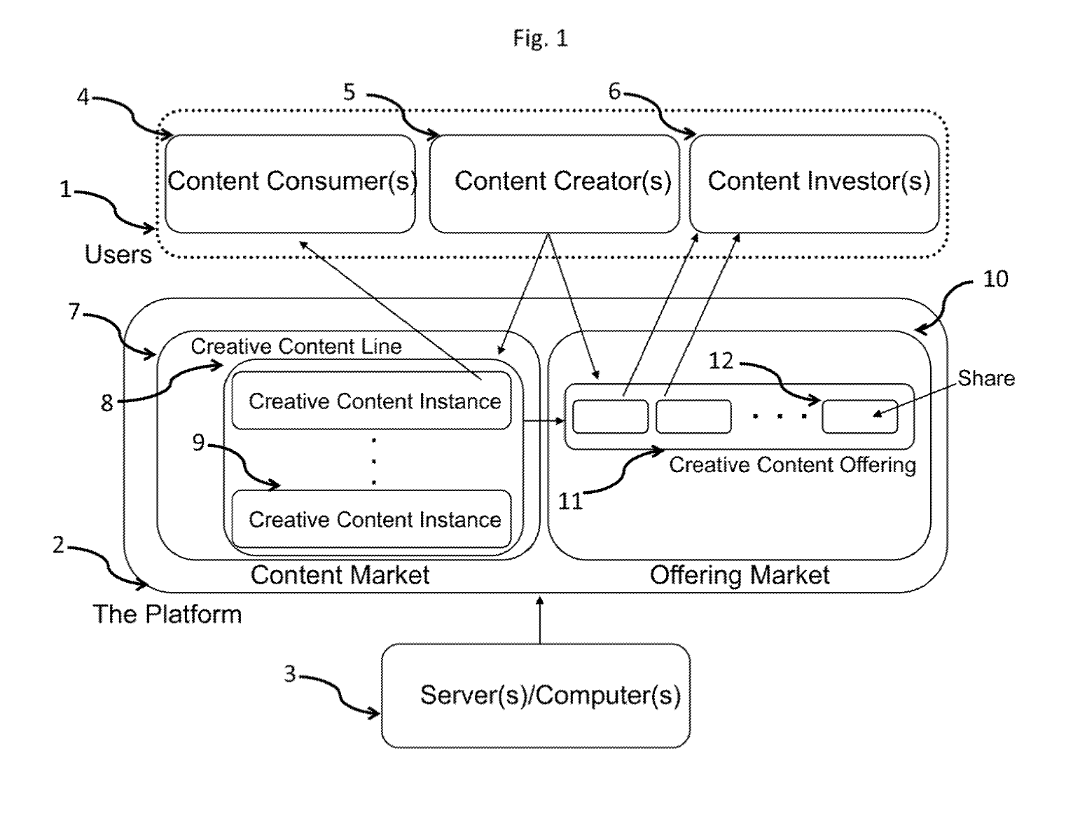

In one embodiment of the invention as shown in FIG. 1, an online marketplace platform/website is provided whereby a plurality of users 1 access the platform 2 over the World Wide Web with the intent to use the software stored on a computer/server system 3 for buying and selling instances or units of creative content/productive output 9 associated with a creative content/productive output line 8 through a content market 7 provided by the algorithms and software comprising the platform 2, and/or browsing an offering market 10 whereby shares 12 of a creative content/productive output offering 11 that is associated with a given creative/productive output content line 8 and thereby lay claim to a percentage of future revenues generated by sales conducted through the content market of creative content/productive output Instances associated with said creative content/productive output Line.

Any user of the platform 2 who wishes to sell or has sold creative content/productive output 9 is a content creator or content owner 5. Any user of the platform who wishes to buy or has purchased creative content/productive output is a content consumer 4. Any user of the platform who wishes to purchase or has purchased shares of an offering is a content investor 6. In some embodiments of the platform it is possible for any user of the platform to be any combination of the three categories of user so described.

The content market is understood to be a website or collection of a plurality of websites within the platform 2 whereby a plurality of content consumers 4 may browse a plurality of creative content/productive output lines 8 produced by a possible plurality of content creators 5 and purchase a plurality of creative content/productive output instances 9 of lines 8 from one or more content creators 5. A content creator 5 may produce a plurality of lines 8 and may sell a plurality of instances 9 from each of those lines. In some cases, a creative content/productive output line may be composed of only a single creative content/productive output instance 9 (e.g., an original painting produced by an artist). The content creator or owner 5 decides how they will price instances 9 from each of their lines 8. The platform 2 provides a software means for content creators and owners 5 to specify, inspect, and modify their pricing schemes. In addition, a third party such as the platform operator may set the pricing.

A content creator 5 may choose to associate a creative content/productive output offering 11 with any of their creative content/productive output lines 8. The content creator 5 may be required to take the following steps to create an offering 11: (1) Determine what percentage of sales from their creative content/productive output line they will share with content investors (their split); (2) Determine how much money they would like to raise from content investors for a particular split; (3) Determine how many shares will be offered for a split (this, in conjunction with step 1, determines what percentage of revenues each share is worth); (4) Determine how much time they would like to allow for their offering to be fully subscribed (i.e., all requested monies raised); (5) Specify any limits on number of shares owned by any given content investor.

The offering market is understood to be a website or collection of a plurality of websites within the platform 2 whereby a plurality of content investors 6 may browse a plurality of creative content/productive output offerings 11 associated with given creative content/productive output lines 8 and purchase shares 12 of an offerings 11 from their respective content creators 5. A content creator 5 may produce a plurality of offerings 11 and may sell a plurality of shares 12 from each of those offerings 11. The content creator or owner 5 decides how they will price shares 12 from each of their offerings 11 via the five-step process described in the previous paragraph. The platform 2 provides a software means for content creators 5 to specify, inspect, and modify their offerings 11.

The software and algorithms comprising the platform 2 track sales of creative content/productive output instances 9 through the content market and appropriately partition revenues from a creative content/productive output line 8 between a content creator 5 and one or more content investors 6 according to the terms of the offering 11 associated with one of more lines 8. Such tracking may be performed for one or more offerings 11 associated with the plurality of content creators 5. The software and algorithms that track, store, access, and manage the data associated with such processes as well as the software and steps enabling the creation and management of offerings are known to those of skill in the art. The platform 2 may also provide electronic records and reports that are compliant with relevant governmental reporting requirements related to securities and taxes.

In addition, the data generated by user 1 interactions with the platform 2 are valuable and can be usefully exploited. For example, the sales data associated with creative content/productive output instances may be used to drive gamification strategies whereby users are encouraged to predict the performance of given creative content/productive output lines 8 and are rewarded when their predictions are accurate. Such data can also be used to inform content creators 5 about the performance of their line 8 within the marketplace and could also be used in aggregate to glean scientific and sociological information about how markets work generally.

Benefits of an embodiment of the invention are derived from the fact that it: allows content creators 5 to raise immediate funds against the future value of their creative content/productive output; allows content creators 5 to build a cadre of individuals and/or content investors whose financial incentives are aligned with their own and are thus more likely to help advertise and protect the creative content/productive output from unauthorized copying and distribution; and allows individuals with only modest amounts of capital to deploy their excess funds productively by becoming investors 6.

The platform 2 may be operated in two different modes depending on whether or not creative content/productive output instances sold through the content market are delivered to the content consumer via the platform 2 or via some third-party mechanism. The type of creative content/productive output offered by the content creator(s) determines which mode will be used. If the content is delivered from the platform 2 (e.g., content consumers download digital content such as a video from the platform) then it is enclosed. If products are delivered to consumers by another party then the platform is semi-enclosed.

The platform 2 may also be deployed in a semi-enclosed manner. In this embodiment, an Outdoor Sports Company A (the lone content creator/owner) may wish to recoup funds associated with the development of a new line of backpacks. An offering associated with the backpack line is generated through the platform 2 to raise the requested sum of money for the specified split. Digital representations of the backpack (i.e., photos) are uploaded to the content market and content consumers are able to view and purchase the backpacks. The purchase information is managed by the platform 2 and subsequently Company A is notified that a content consumer 4 has made a purchase. Company A is responsible for delivering the backpack to content consumer 4 but the platform 2 appropriately manages the flow of funds to the appropriate content Investors 6.

In another embodiment, Pharmaceutical Company A may desire to fund the development of a new drug. It can create an offering through the platform 2 and raise the requested funds. The offering is structured such that future sales of any product generated by the proposed line of research will pay out appropriately to the content investors. Future drug sales are conducted through the platform's content marketplace which leads to transparent payment of monies to the content investors but delivery of the drugs to the content consumers is enacted by Pharmaceuticals Company A.

In yet another embodiment, Municipality A would like to fund the construction of a red-light camera at a dangerous intersection. Rather than use tax revenue, the municipality constructs an offering through the platform whereby a portion of revenues from fines generated by the camera system are paid out to content investors. The platform's content market is used by the municipality as the payment processing system for fines generated by the camera and hence all monies can be appropriately tracked and apportioned.

The platform can be employed as an enclosed system for the sale of digital creative content/productive output as well as any other thing, tangible and intangible, or service. Content consumers 4 can download creative content/productive output instances 8 from the platform 2 through the content market. There is no ambiguity about the flow of content and money between content consumer 4, content creator 5, and content investor 6. Digital movies, computer software, smart-phone applications, digital art, digital books, branded merchandise, and digital music are some of the examples of creative content that can be sold through the platform 2.

In a preferred embodiment the platform 2 may be in situations in which the content creators 5 are musicians and a single creative content/productive output line 7 is a music album or song generated by a musician. In what follows, content consumers 4 are also called listeners and content investors 6 are referred to as investors.

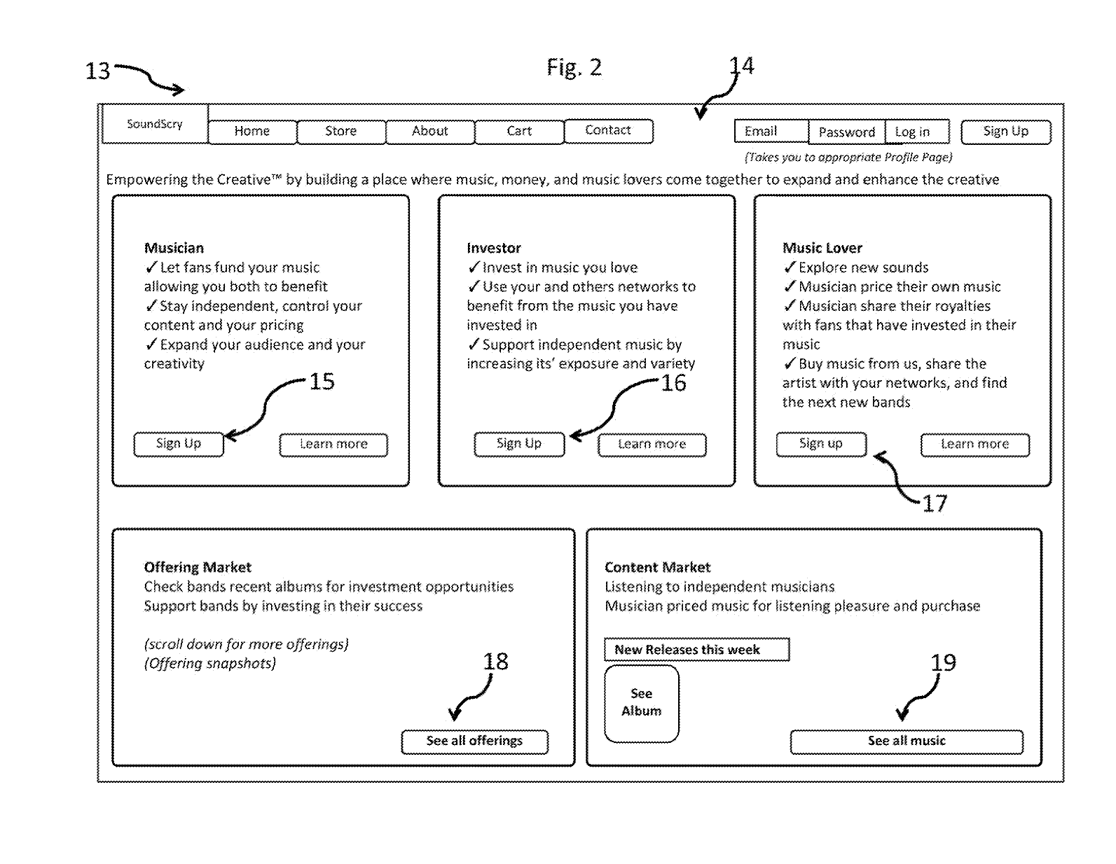

FIG. 2 illustrates a starting web page 14 of website 13 which is a music-centric embodiment of the platform 2 that has been previously described herein. The platform 2 may be comprised of the software, algorithms, and databases that enable users to interact with a content market and an offering market enabling the revenues generated by the sale of creative content/productive output to content consumers through the content market to be appropriately tracked and apportioned among the content creators and content investors and, further, that allows users to become content consumers, content creators, and content investors as appropriate and, further, to manage the creative content/productive output that they have bought, wish to buy, have sold, wish to sell, or have invested in or wish to invest in.

Website 13 is a collection of one or more web pages, including web page 14 and an embodiment of the platform. Website 13 is understood to have web pages which are specific to managing digital music as creative content/productive output and it should be understood that any specificity provided herein does not limit the scope of the disclosure. While this exemplary embodiment is described as a web-based system, systems utilizing dedicated software and/or standalone machines may alternatively be implemented. Such a web-based system uses a server computer (not shown) and a user computer or other device (not shown). The server computer is connected to a network, for example, the World Wide Web and responds to queries from user computers. The server either stores or is able to retrieve or build various web pages to be sent to the multiple user computers that are likewise coupled to the network. Accordingly, the server transmits HTML code or other web page files for the below described web pages to the user computer. The user computer has a browser program which may be proprietary software used only for interacting with the server, or may be a more generic browser capable of viewing many different websites and interacting with multiple servers. Alternatively, instead of a user computer, a wireless device such as a PDA or smart phone may be used to receive the web pages and interact with the user. For standalone implementations, a single computer has access to both the information of the server and the graphic files for the user interface, and an interaction capability similar to that of a browser. In other embodiments, a combination of local software and network access resources may be combined to provide the full functionality similar to the web-based system.

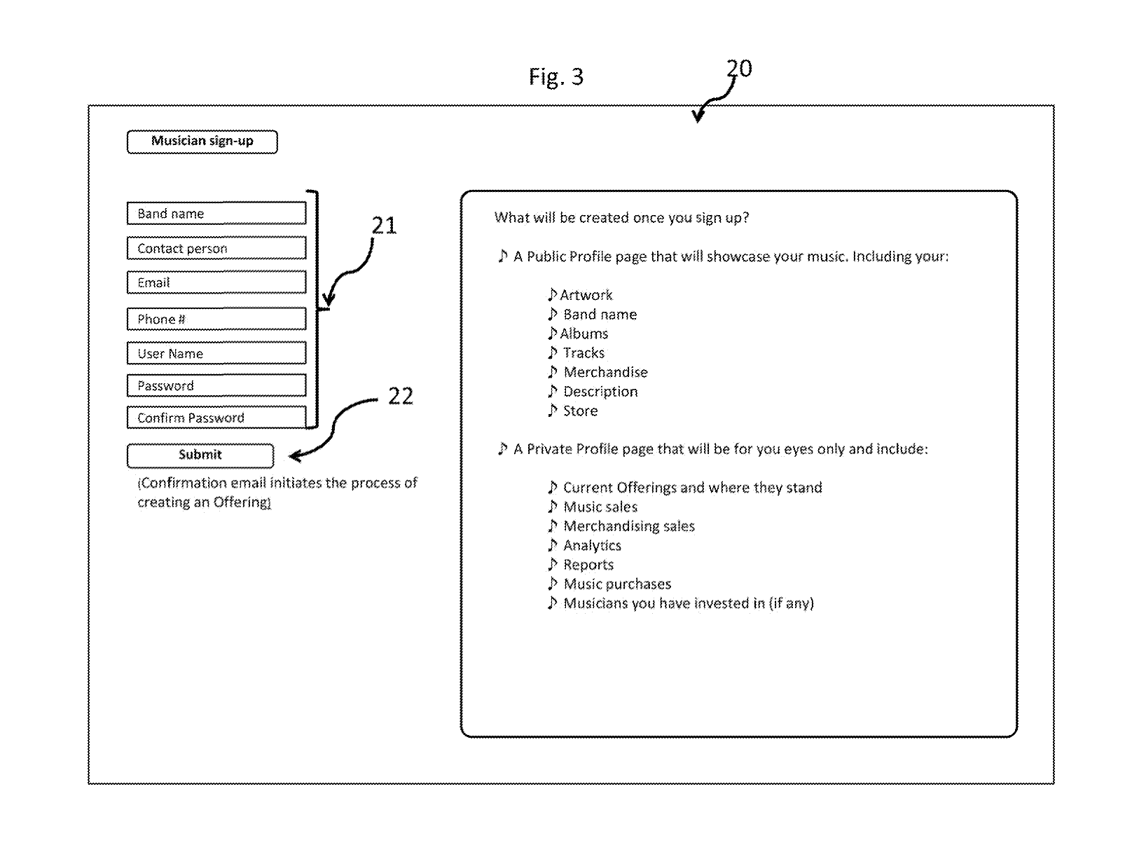

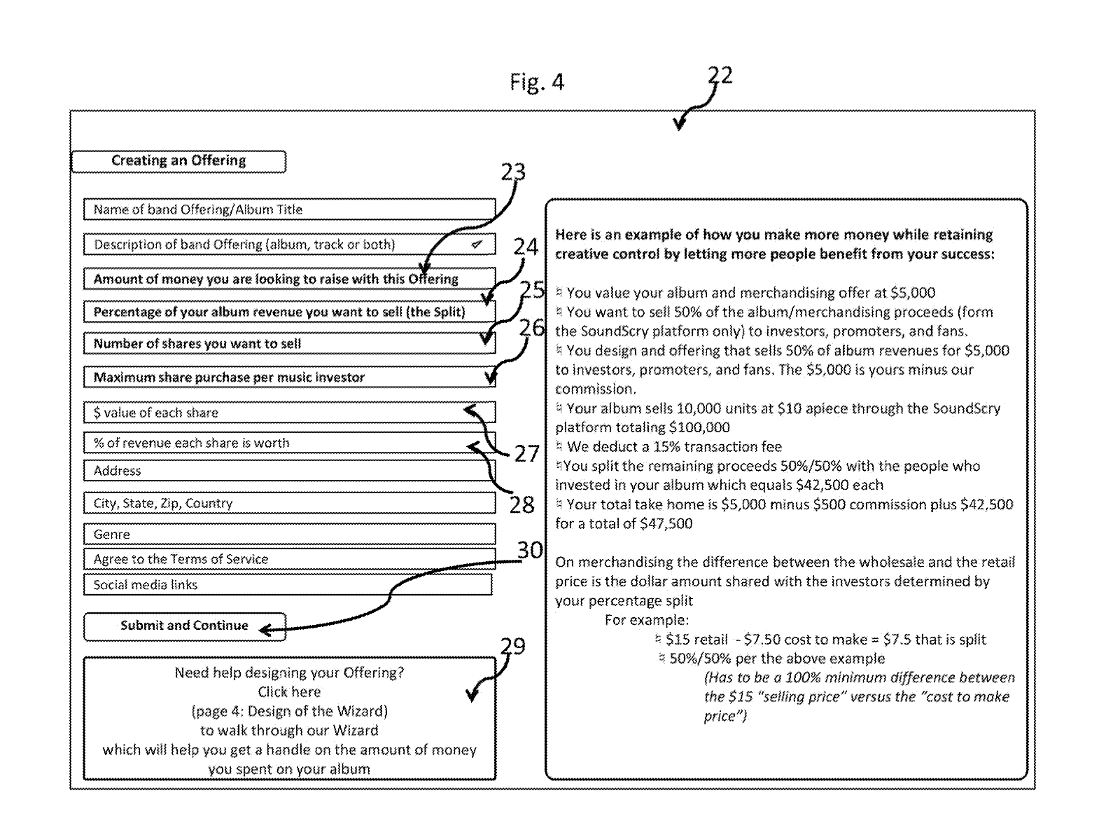

A user may become a musician by selecting button 15, which leads to the web page 20 shown in FIG. 3. Web page 20 leads the user through a data acquisition process 21, which upon completion identifies the user as a musician. Once the user has submitted their information by selecting 21 they are taken to web page 22 shown in FIG. 4 where they can begin to design an offering for their album.

When designing an offering, the musician is prompted to enter how much money they would like to raise from investors 23, how much of their album revenue they are willing to share with investors (the split) 24, the number of shares they would like to sell 25, and the maximum number of shares they want any one investor to own 26. The dollar value of each share 27 is found by dividing the money desired for the offering 23 by the number of shares to sell 25. The percentage of album revenue that each share is worth 28 is found by dividing the split 24 by the number of shares to sell 25. The musician can select button 29 to link to a page (not shown) that provides an algorithmic process or wizard that helps the musician determine a reasonable asking price. Once the terms of the offering have been determined then it is entered into a queue where it will remain until the musician has submitted the creative content/productive output (digital music tracks) comprising their album and attached it to the information comprising their offering.

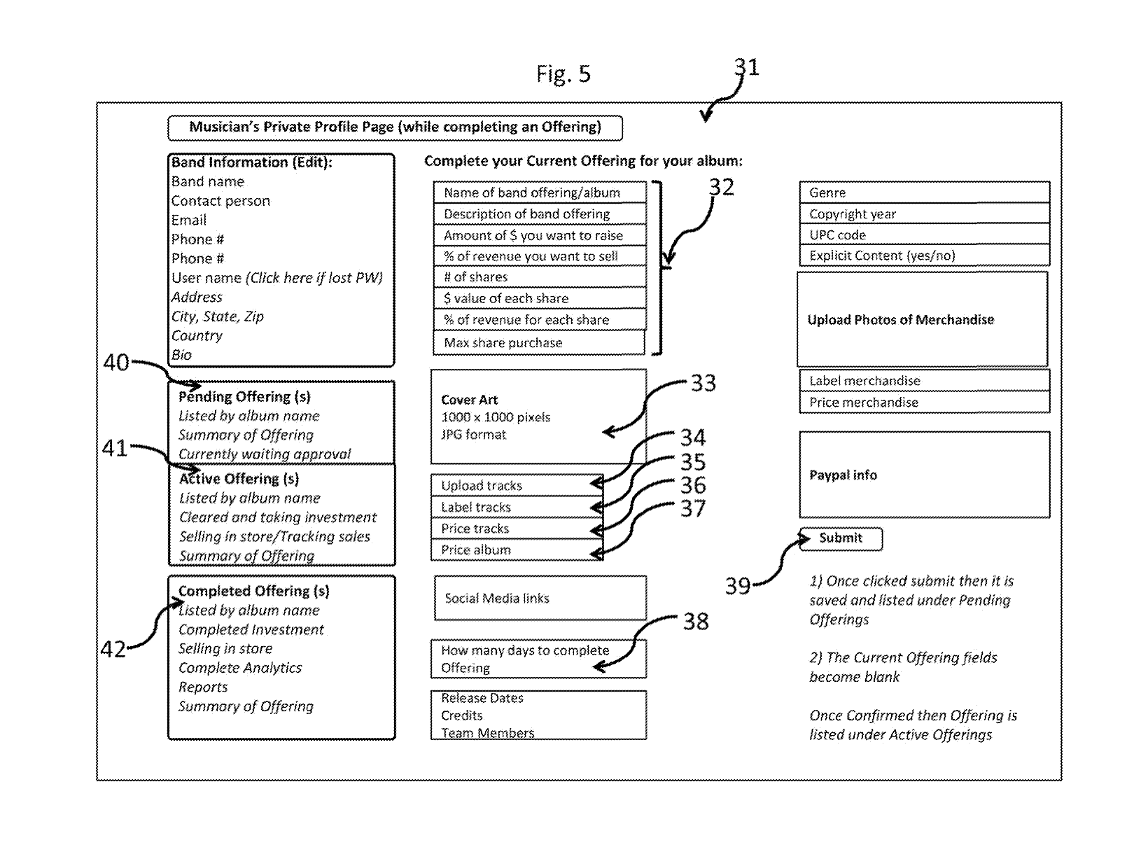

By selecting the button 30 on web page 22 the musician submits their offering into a queue and is linked to web page 31 shown in FIG. 5. Web page 31 is the musician's private profile page where they can manage their creative content/productive output and the offerings associated with their albums. The values in the region 32 are pre-populated with the values that were entered by the musician on web page 22. Selecting button 33 activates a menu-based dialogue box (not shown) that allows the musician to browse their computer hard drive and upload cover art for their album and offering. This art will be displayed to other users in the content market and the offering market. Selecting button 34 activates a menu-based dialogue box (not shown) that allows the musician to browse their computer hard drive and upload digital music tracks that will be included in their album. Selecting button 35 activates a pop-up menu (not shown) that allows the musician to edit the names of the digital music tracks that they have uploaded for their album. Selecting button 36 activates a pop-up menu (not shown) that allows the musician to individually price the digital music tracks that they have uploaded for their album. Selecting button 37 activates a pop-up menu (not shown) that allows the musician to price their entire album for when it is purchased as a single entity. The musician enters the number of days they would like to allow for their offering to become fully subscribed (all shares purchased) in box 38. Once the musician has uploaded their album they submit their offering by selecting button 39.

Once the offering has been submitted, it is entered into a queue where it will be reviewed prior to release to the public in the offering market. Any offerings that have not yet been reviewed and approved are labeled pending and a summary of pertinent information related to such offerings is shown in the active, scrollable window 40. An active offering has been approved for display in the offering market and shares of the offering are currently being sold to investors. A summary of pertinent information related to each active offering is shown in the active, scrollable window 41. A completed offering has been fully subscribed by investors and is no longer for sale in the offering market. The album associated with the offering is selling in the content market and the musician and relevant investors are earning revenues from the sale of the album. A summary of pertinent information related to each completed offering is shown in the active, scrollable window 42. The information displayed in all the populated data display windows of web page 31 is managed, calculated, and routed to the appropriate data storage locations by the software and algorithms comprising the platform.

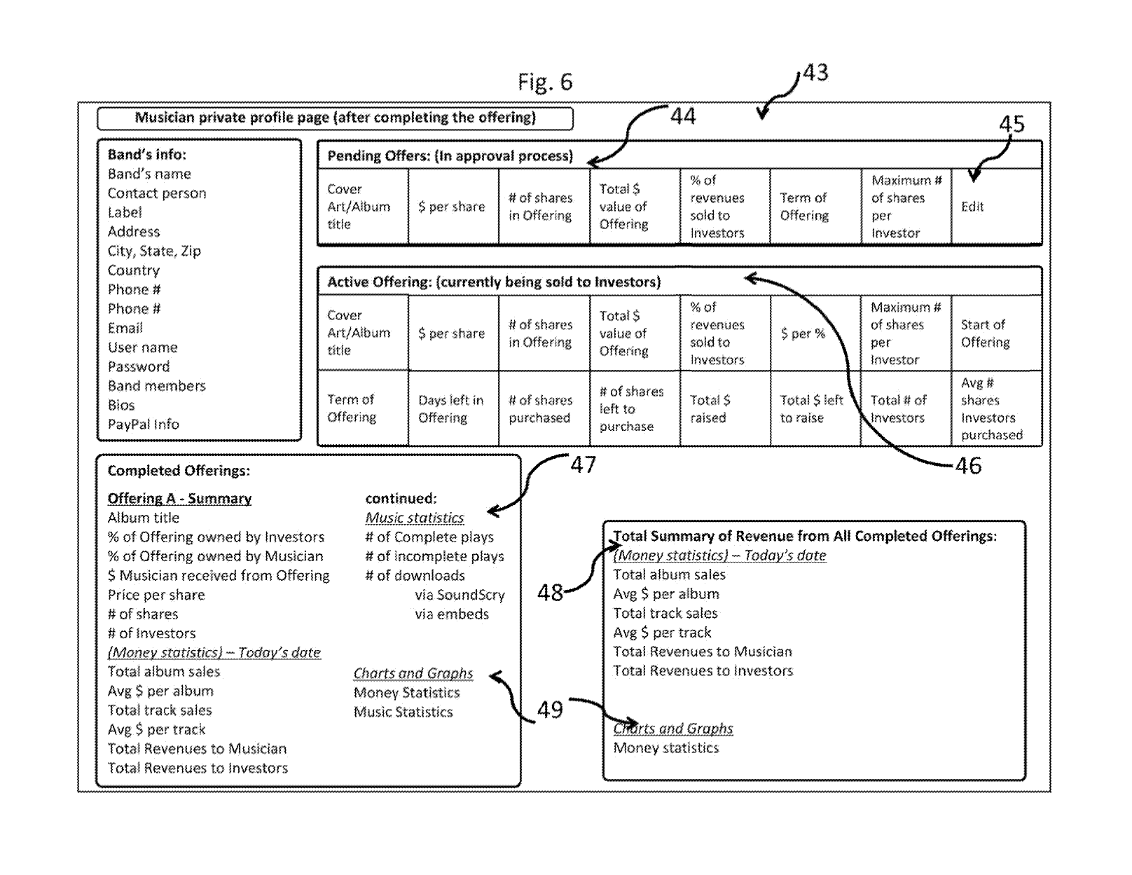

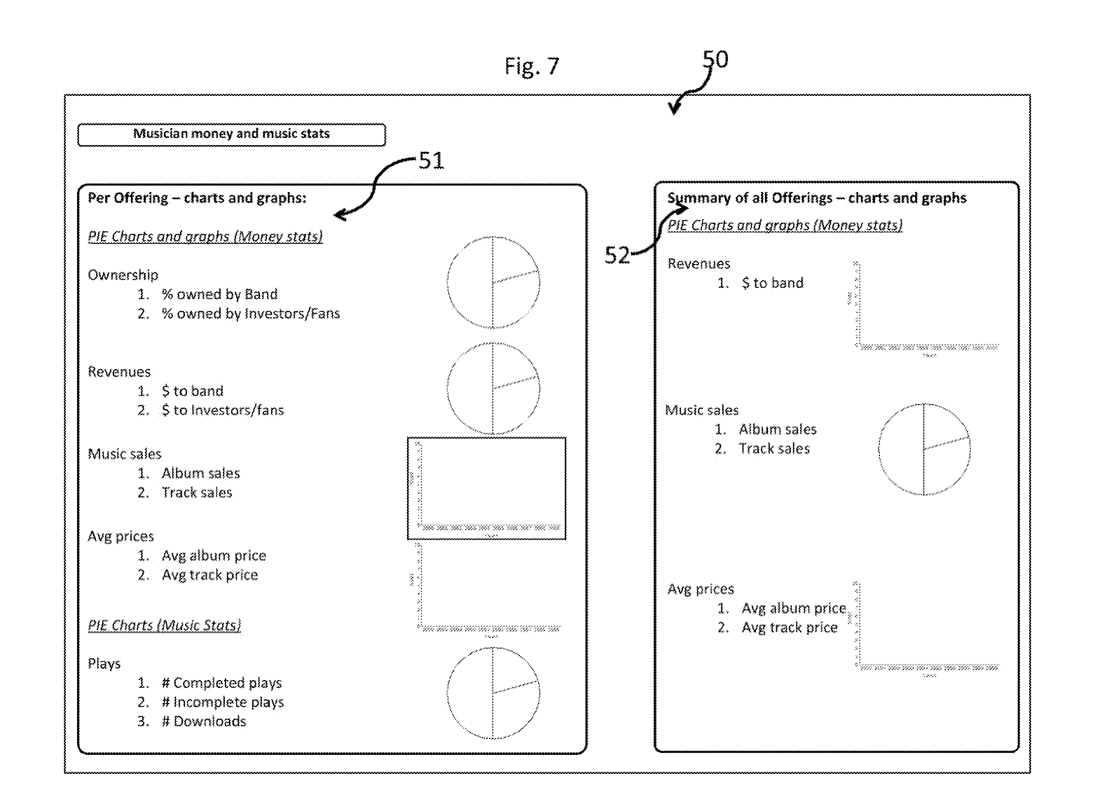

Once the offering has been submitted by selecting button 39 the musician is taken to web page 43 shown in FIG. 6, which is their private profile page where the musician manages their offerings. The active, scrollable window 44 shows a summary of pertinent information regarding pending offerings and allows the musician to edit those offerings by selecting button 45. The active, scrollable window 46 shows a summary of pertinent information regarding active offerings that are currently being sold to investors through the offering market. The active, scrollable window 47 shows a summary of financial and statistical information concerning proceeds from, and sales of, albums and their respective completed offerings. Window 48 provides a summary of sales and revenues for all albums and their attendant offerings generated by the musician. Selecting either button 49 links the musician to web page 50 shown in FIG. 7 where financial and statistical information shown in windows 47 and 48, shown in FIG. 6, may be shown in graphical form (e.g., pie charts and bar and line graphs) in windows 51 and 52, respectively. The information displayed in all the populated data display windows of web pages 43 and 50 is managed, calculated, and routed to the appropriate data storage locations by the software and algorithms comprising the platform.

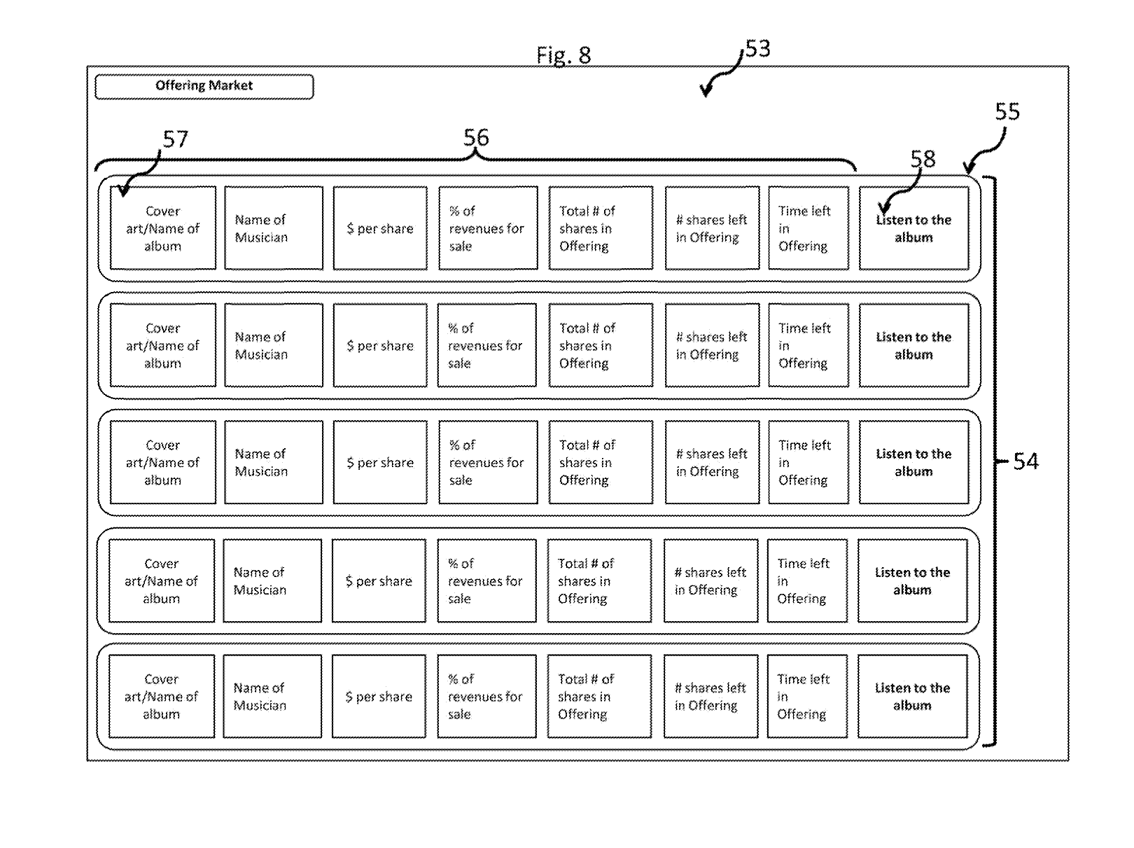

Once a musician's pending offering has been upgraded to approved, the software and algorithms comprising the platform provide a summary of the offering 55 in the offering market of web page 53 of FIG. 8 where it can be viewed by users in the system alongside other active offerings of other musicians 54.

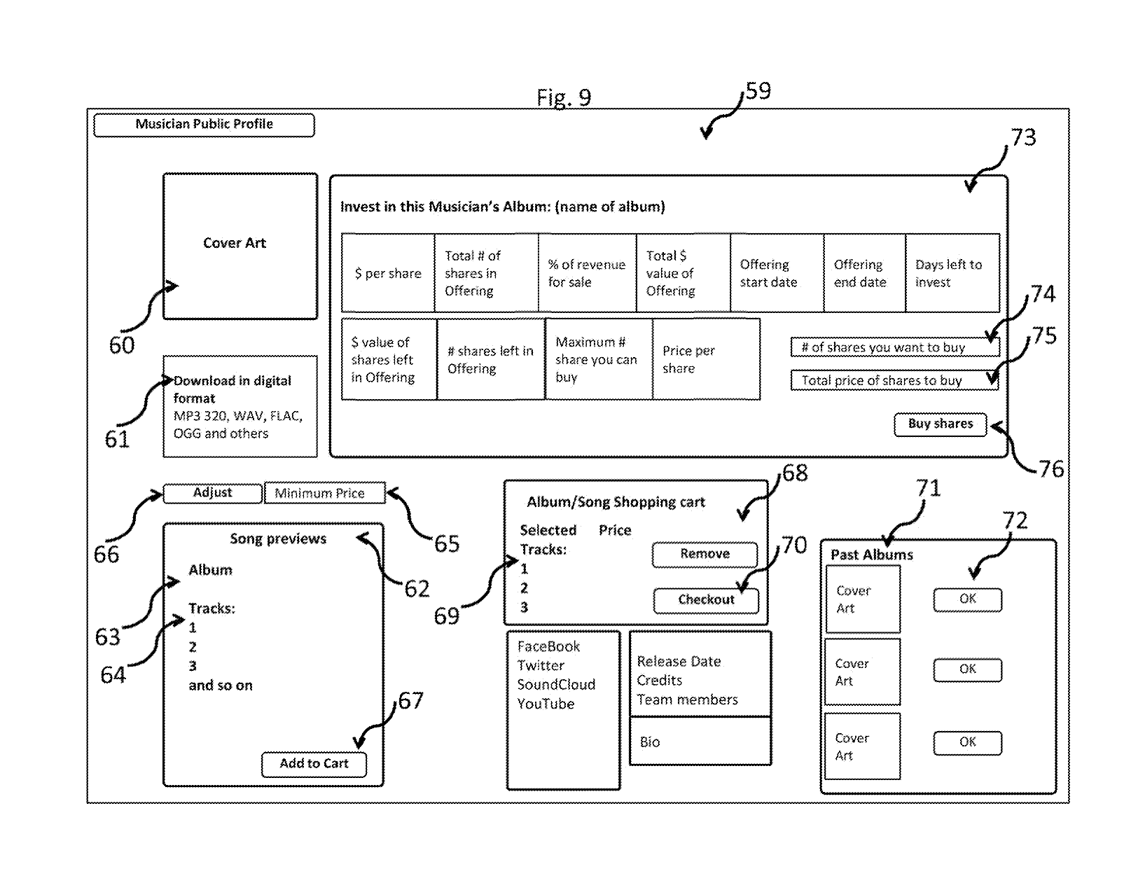

Pertinent information about the offering 56 is pre-populated from the information entered by the musician during the offering design stage on web page 22. A thumbnail image of the cover art uploaded at 33 is displayed at 57. Selection of button 58 corresponding to a given offering takes a user to the respective public profile page for that musician as exemplified by web page 59 shown in FIG. 9.

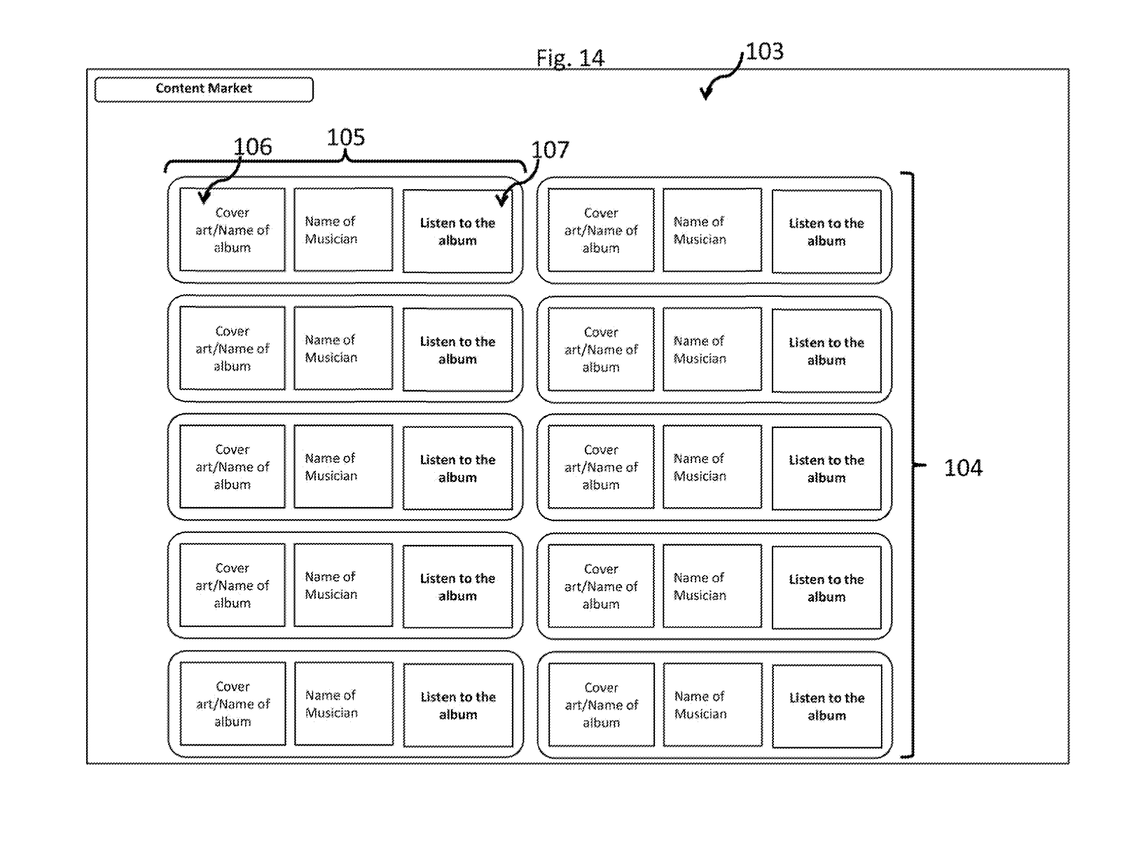

The cover art displayed in window 60 corresponds to the offering/album that was selected by the user from the offering market 53 or the content market 103, shown in FIG. 14. This is the same art that was uploaded by the musician at 33. The user may choose the format of the digital music they will download by selecting 61 which activates a pop-up dialogue box (not shown) that allows the user to select from a list of available download formats. The user may sample individual songs from the album by selecting from the list of tracks 64 that are shown in the preview window 62.

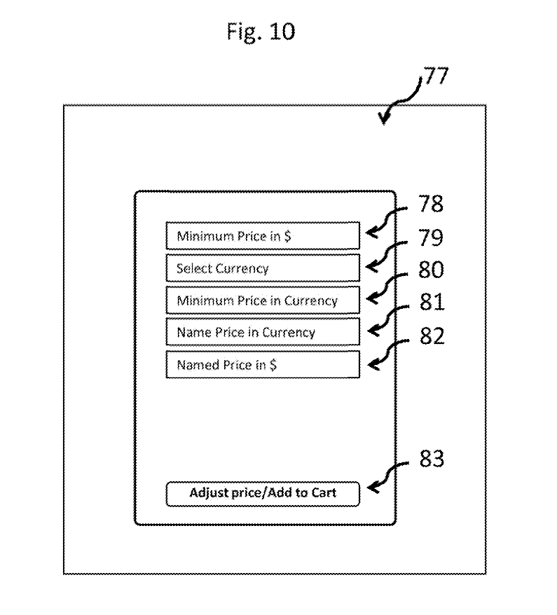

When a track is selected for sampling the minimum price for that song, as determined by the musician, displays in 65. If the album button 63 is selected, the minimum price for the entire album will display in 65. The user/listener may elect to offer more money for each song/album by selecting 66, which opens the pop-up dialogue box 77 shown in FIG. 10.

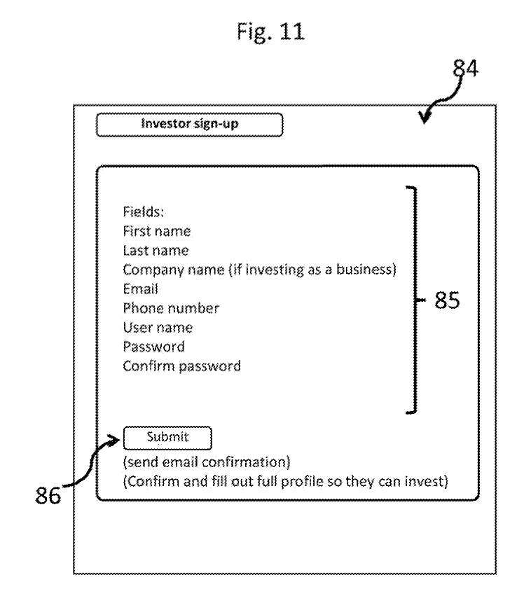

The user is shown the minimum price in U.S. dollars for the track/album in 78. They may select 79, which activates a drop-down menu (not shown) from which they may select an alternate currency (default currency is U.S. dollars). Once selected, the minimum price in the selected currency is displayed in 80. The user may then enter a new price for the track/album in 81. The named price is then displayed in U.S. dollars in 82. Selection of 83 dismisses the pop-up window 77 and adds the track/album to the shopping cart 68 with the appropriate updated price. Alternatively, the user may elect to directly add a track/album to the shopping cart for the minimum requested price by selecting 67. A list of tracks/albums selected for the shopping cart is provided 69. Selecting 70 links to a standard payment-processing page (not shown) where payment information may be entered. A download manager (not shown) allowing the user to select a download location on their hard drive is activated once payment has been received. The user may browse other albums generated by the same musician in the active, scrollable window 71. The user may preview tracks from these other albums by selecting the appropriate button 72, which updates the cover art 60 and the preview window 62 with information corresponding to the selected album. Any album with an associated active offering will have the appropriate information displayed in the offering information window 73. Albums with completed offerings will have an inactive window 73 but will still have an active song preview window 62 where tracks can be sampled and purchased. A user can invest in albums with active offerings by entering the number of shares to purchase 74 (which updates the total price 75) and selecting 76, which leads to a payment processing window (not shown). Investing in an offering can only be performed, however, if the user has followed the process required to become an investor. This process can be initiated by selecting 16 on home page 14 which leads to pop-up box 84 shown in FIG. 11.

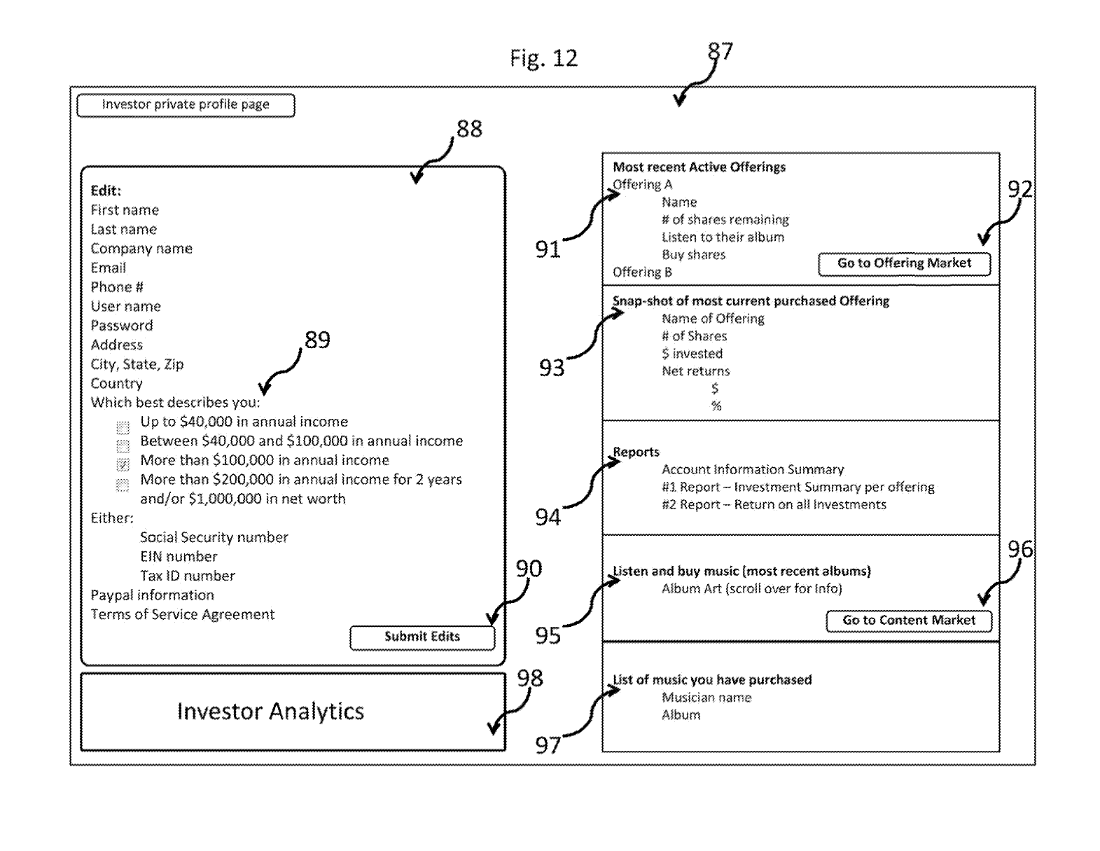

Pop-up box 84 is the start of a data acquisition process where the user may provide personal details 85 including a password. Upon selecting submit 86 the user is taken to their personal investor profile page, web site 87 shown in FIG. 12, where they can edit their information 88 and are prompted to indicate their yearly salary information 89 if required by extant government regulations. The user can then submit any personal information edits and salary information by selecting 90 at which point they become an investor and are allowed to invest in offerings submitted by musicians. The most recent offerings submitted by musicians continually update the active, scrollable window 91 where the investor navigates to the corresponding musician's public profile by selecting the offering, or, alternatively, can navigate to the offering market 53 by selecting 92.

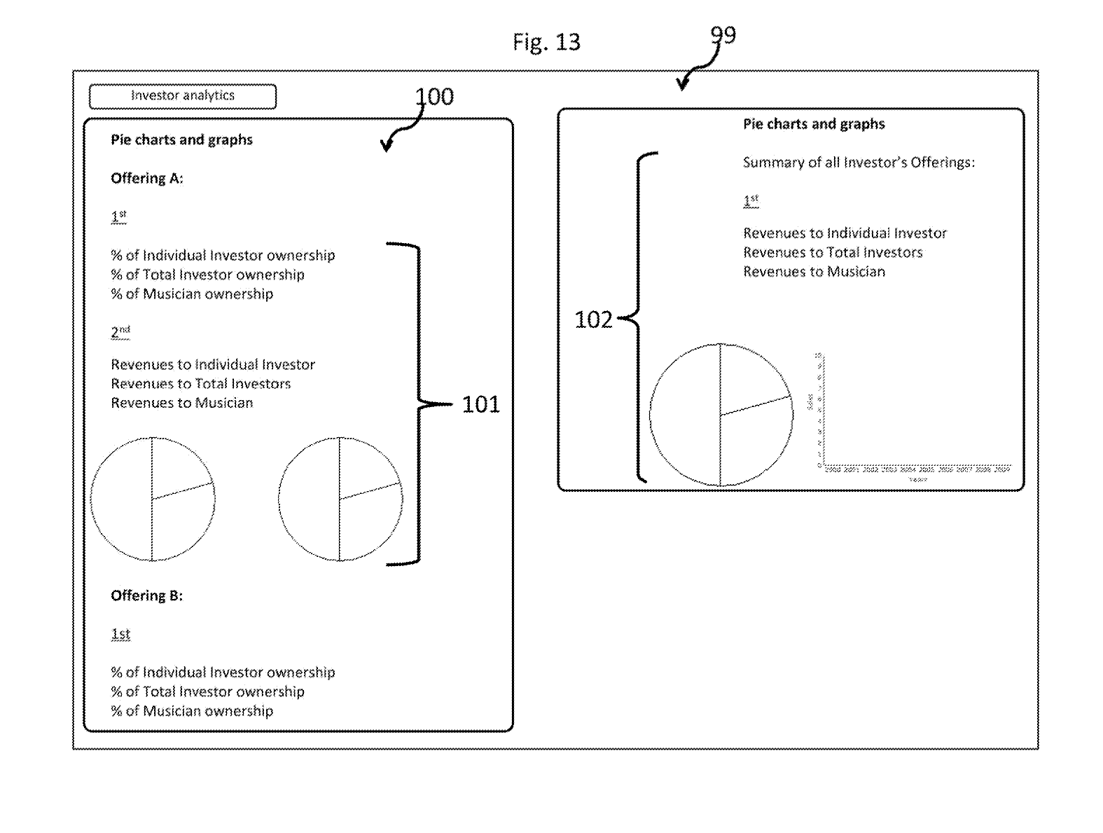

A summary of the most recent offering purchased by the investor is displayed in the active window 93. The user can select a report from the scrollable window 94 and open a pop-up window (not shown) that allows them to download document versions of their investment summaries to a specified location on their computer's hard drive. The most recently released albums are displayed in the active, scrollable window 95 where the investor may select a given displayed album and transfer to the corresponding musician's public profile 59. Alternatively, the investor may select 96 to go directly to the content market 103. A list of the investor's purchased albums/tracks is shown in the active, scrollable window 97. The user may select 98 to navigate to their personal graphical investor analytics page 99 shown in FIG. 13 where the investor can view financial statistics related to individual offerings 100 in numerical and graphical form 101. Overall financial statistics for all offerings are also provided in numerical and graphical form 102.

Selecting 17 from home page 14 links the user to a sign-in page (not shown) where they may become a registered listener. A registered listener is provided with a personal profile page (not shown) where they can review music that they have purchased. Selecting 18 from home page 14 links the user directly to the offering market 53 shown in FIG. 8.

Selecting 19 from home page 14 links the user directly to the content market 103 shown in FIG. 14. The user may browse the plurality of albums 104 that are for sale from the plurality of musicians within the web site 13. Each individual album representation 105 within the market displays a thumbnail of the image that was uploaded by the musician at 33. Selecting 107 takes the user to the musician's public profile page 59.

What is claimed is:

1. A method of electronically forming a system to allow a user to invest in and obtain a product including the steps of:
presenting a website to a user, the website providing at least one product offering to a user;
electronically obtaining product to be displayed on said website;
electronically allowing a user to view said product;
electronically allowing a user to invest in said product offering;
electronically allowing a user to purchase said product;
electronically tracking revenues generated by purchases of said product;
electronically apportioning said revenues to a user based on their investment; and
electronically allowing a user to obtain said product.

2. The method of claim 1 wherein the product is a digital product and said system electronically delivers said digital product to said user thereby forming an enclosed system.

3. The method of claim 2 wherein said digital product is comprised of one or more musical compositions.

4. The method of claim 1 wherein the product is a tangible product and said system electronically arranges for the delivery of said tangible product to said user thereby forming an enclosed system.

5. The method of claim 1 wherein the product owner is allowed to assign a purchase price to the product.

6. The method of claim 3 wherein said digital product is a collection of individual songs comprising an album and said digital product owner is allowed to determine if individual songs may be sold.

7. The method of claim 1 wherein the product owner is allowed to specify an offering for the sharing of revenues associated with the product, said offering representing a percentage of revenues retained by the owner and percentage of revenues sold to investors as a fixed number of shares at a fixed price per share representing a proportional split of investor revenue.

8. The method of claim 1 wherein the product owner is allowed to specify a price for the offering.

9. The method of claim 7 wherein the investor is limited to a predetermined number of shares.

10. The method of claim 1 wherein product owners and investors can view total purchases of the product.

11. The method of claim 1 wherein a user is able to view a plurality of offerings from a plurality of product owners.

12. The method of claim 1 wherein said purchases and investments are processed by said system and said system electronically delivers said product thereby forming an enclosed system.

13. The method of claim 1 wherein said purchases and investments are processed by said system thereby forming a semi-enclosed system.

14. A method of electronically forming a system to allow a user to invest in a product and share in the revenue generated by sales of the product including the steps of:
presenting a website to a user, the website providing at least one product offering associated with a product to a user;
electronically allowing a user to view said product;
electronically allowing a user to invest in said product offering;
electronically allowing a user to purchase said product;
electronically tracking revenues generated by purchases of said product; and
electronically apportioning said revenues to a user based on their investment.

15. The method of claim 14 further including obtaining said product from a product owner.

16. The method of claim 15 further including apportioning said revenues to said user and said product owner based on said investment.

17. The method of claim 14 wherein said purchases and investments are processed by said system and said system electronically delivers said product thereby forming an enclosed system.

18. The method of claim 14 wherein said purchases and investments are processed by said system thereby forming a semi-enclosed system.

19. The method of claim 14 wherein said investor is limited to a predetermined number of shares of said offering.

20. The method of claim 14 wherein the product is a collection of individual songs comprising an album and the product owner is allowed to determine if individual songs may be sold.
